(19) United States
(12) Patent Application Publication
(10) Pub. No.: US 2024/0327262 A1
(43) Pub. Date: Oct. 3, 2024

(54) NITROGEN REMOVAL SYSTEM AND PROCESS

(71) Applicant: Black & Veatch Holding Company, Overland Park, KS (US)

(72) Inventors: Sandeep Sathyamoorthy, Overland Park, KS (US); Eric Daniel Redmond, Overland Park, KS (US); Bishav Bhattarai, Overland Park, KS (US); Leon Scott Downing, Overland Park, KS (US)

(21) Appl. No.: 18/615,803

(22) Filed: Mar. 25, 2024

Related U.S. Application Data
(60) Provisional application No. 63/492,825, filed on Mar. 29, 2023.

(51) Int. Cl. C02F 3/30; C02F 3/12; C02F 101/38

(52) U.S. Cl. CPC C02F 3/301; C02F 3/1221; C02F 3/1263; C02F 2101/38; C02F 2209/001; C02F 2209/34

(57) ABSTRACT

A wastewater treatment system comprising a basin, an N2O sensor, and an organic carbon source. The basin is configured to subject wastewater to an activated sludge-based biological treatment wherein nitrogen is removed from the wastewater. The N2O sensor is positioned in the basin and configured to produce an N2O detection in the biological treatment. The organic carbon source is fluidly connected to the basin. The wastewater treatment system is configured to dose organic carbon from the organic carbon source to the biological treatment based on the N2O detection so that the wastewater treatment system controls an N2O level of the biological treatment via the organic carbon.

### RELATED APPLICATION

This regular utility non-provisional patent application claims priority benefit with regard to all common subject matter of U.S. Provisional Patent Application Ser. No. 63/492,825, filed Mar. 29, 2023, entitled “NITROGEN REMOVAL SYSTEM AND PROCESS”. The provisional patent application is hereby incorporated by reference in its entirety into the present patent application.

### BACKGROUND

Nitrous oxide (N2O) emission is a significant concern for decarbonization of biological nutrient removal (BNR) in activated sludge processes for treating wastewater. Nitrifying and denitrifying bacteria both emit N2O under different biological stress conditions, which complicates N2O mitigation. Energy and organic carbon efficient removal of nitrogen from wastewater can increase the risk of N2O emissions. The use of N2O sensors in an attempt to minimize N2O emissions via control of aeration is known, but not necessarily sufficient nor particularly effective.

### SUMMARY OF THE INVENTION

Embodiments of the present invention solve the above-mentioned problems and other problems and provide a distinct advance in the art of N2O mitigation in treating wastewater to remove nitrogen while minimizing energy and organic carbon requirements. More particularly, the present invention provides a wastewater treatment system and method that controls an N2O level of a biological treatment via dosing organic carbon to the biological treatment according to N2O detection in the biological treatment.

Furthermore, the present invention utilizes N2O sensing to control carbon addition to effect nitrogen removal via population control to enable shortcut nitrogen removal techniques. In that vein, N2O sensing can be used to dose carbon to promote NO2 production. In addition to N2O emissions mitigation/prevention, the present invention may be applied to N2O emissions control of nitrification/denitrification processes and shortcut nitrification processes (e.g., using N2O for shortcut optimization). Such control may entail leveraging N2O emissions readings for both optimized process control for nitrogen removal and reduction of N2O emissions.

An embodiment of the invention is a wastewater treatment system comprising a basin, an N2O sensor, and an organic carbon source. The basin is configured to subject the wastewater to an activated sludge-based biological treatment wherein nitrogen is removed from the wastewater. The N2O sensor is positioned in the basin and configured to produce an N2O detection in the biological treatment. The organic carbon source is fluidly connected to the basin. The wastewater treatment system is configured to dose organic carbon from the organic carbon source to the biological treatment based on the N2O detection so that the wastewater treatment system controls an N2O level of the biological treatment via the organic carbon. The present invention also may apply to systems that effect N2O emissions harvesting.

Another embodiment is a method of treating wastewater. The method comprises a step of subjecting the wastewater to an activated sludge-based biological treatment in a basin wherein nitrogen is removed from the wastewater. The method further comprises a step of producing an N2O detection in the biological treatment via an N2O sensor. The method further comprises a step of dosing organic carbon from an organic carbon source to the biological treatment based on the N2O detection thereby controlling an N2O level of the biological treatment via the organic carbon.

Another embodiment is a method of treating wastewater, the method comprising a step of subjecting the wastewater to an activated sludge-based biological treatment in a basin wherein nitrogen is removed from the wastewater. This step includes forming an anaerobic region and an anoxic region in the biological treatment and utilizing continuous flow, cyclic aeration. The method further comprises a step of producing an N2O detection in at least one of the anaerobic region, the anoxic region, and a low dissolved oxygen region for simultaneous nitrification and denitrification. The method further comprises a step of dosing organic carbon from an organic carbon source into the anoxic region of the biological treatment based on a reading of the N2O sensor thereby controlling an N2O level of the biological treatment via the organic carbon. The organic carbon is from at least one of a primary sludge fermentation system, a biomass fermentation system, and an external organic carbon feed product including at least one of glycerol, methanol, and acetate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1a is a schematic diagram of a wastewater treatment system constructed in accordance with an embodiment of the invention;

FIG. 1b is a graph of N2O readings and organic carbon feed over time pursuant to certain operating conditions of the wastewater treatment system of FIG. 1a;

FIG. 1c is a flow diagram of certain method steps of treating wastewater in accordance with another embodiment of the invention;

FIG. 2a is a schematic diagram of a wastewater treatment system constructed in accordance with another embodiment of the invention;

FIG. 2b is a graph of N2O readings and organic carbon feed over time in pursuant to certain operating conditions of the wastewater treatment system of FIG. 2a;

FIG. 2c is a graph of N2O readings and organic carbon feed over time pursuant to certain operating conditions of the wastewater treatment system of FIG. 2a;

FIG. 2d is a flow diagram of certain method steps of treating wastewater in accordance with another embodiment of the invention;

FIG. 3a is a schematic diagram of a wastewater treatment system constructed in accordance with another embodiment of the invention;

FIG. 3b is a graph of N2O readings and organic carbon feed over time pursuant to certain operating conditions of the wastewater treatment system of FIG. 3a;

FIG. 3c is a graph of N2O readings and organic carbon feed over time pursuant to certain operating conditions of the wastewater treatment system of FIG. 3a;

FIG. 3d is a flow diagram of certain method steps of treating wastewater in accordance with another embodiment of the invention;

FIG. 4a is a schematic diagram of a wastewater treatment system constructed in accordance with another embodiment of the invention;

FIG. 4b is a graph of N2O readings and organic carbon feed over time pursuant to certain operating conditions of the wastewater treatment system of FIG. 4a;

FIG. 4c is a graph of N2O readings and organic carbon feed over time pursuant to certain operating conditions of the wastewater treatment system of FIG. 4a; and

FIG. 4d is a flow diagram of certain method steps of treating wastewater in accordance with another embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

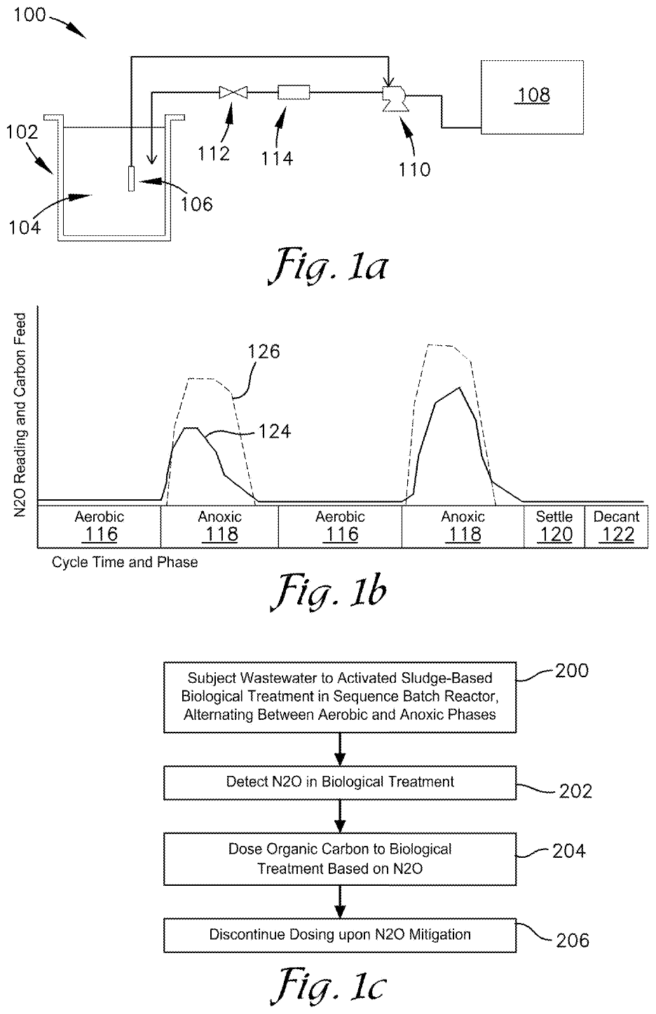

Turning to FIGS. 1a and 1b, a wastewater treatment system 100 constructed in accordance with an embodiment of the invention is illustrated. The wastewater treatment system 100 broadly comprises a sequencing batch reactor 102 for subjecting wastewater to an activated sludge-based biological treatment 104, an N2O sensor 106 for detecting N2O in the activated sludge-based biological treatment 104, an external carbon source 108 for dosing organic carbon to the activated sludge-based biological treatment 104, and organic carbon flow control components including a control pump 110, a control valve 112, and a flow meter 114 connected between the sequencing batch reactor 102 and the external carbon source 108.

The sequencing batch reactor 102 treats the wastewater by cycling through aerobic phases 116 and anoxic phases 118 to remove nitrogen. The sequencing batch reactor may also utilize a settle phase 120 and a decant phase 122. The invention may apply to fixed film applications, suspended solids applications, and other applications.

The N2O sensor 106 may be positioned in the sequencing batch reactor 102 and may be communicatively coupled to the control pump 110. The N2O sensor 106 may produce an N2O detection in the activated sludge-based biological treatment. For example, the N2O sensor 106 may be configured to detect an amount of N2O, generate a signal representative of the N2O amount, and transmit the signal to the control pump 110. The N2O sensor 106 or another sensor may also be configured to produce a secondary measurement detecting nitrite or nitrate.

The external carbon source 108 may be fluidly connected to the sequencing batch reactor 102 for providing external organic carbon feedstock (hereinafter organic carbon) to the sequencing batch reactor 102. The organic carbon may be from at least one of a primary sludge fermentation system, a biomass fermentation system, and an external organic carbon feed product such as glycerol, methanol, acetate, or another compound that provides chemical oxygen demand.

The control pump 110 metes organic carbon from the external carbon source 108 to the activated sludge-based biological treatment 104 in the sequencing batch reactor 102 according at least in part to the amount of N2O in the activated sludge-based biological treatment 104 as detected by the N2O sensor 106. To that end, the control pump 110 may be communicatively coupled to the N2O sensor 106.

The control valve 112 may be fluidly connected between the control pump 110 and the sequencing batch reactor 102 to ensure organic carbon is meted to the sequencing batch reactor 102 only when desired, and/or to prevent backflow.

The flow meter 114 may be fluidly connected between the control pump 110 and the control valve 112. The flow meter 114 may be used to determine an amount or rate of organic carbon being delivered to the sequencing batch reactor 102. This may at least partially inform the control pump 110 to increase or decrease its output.

It should be understood that other arrangements of the above control components, and other control assemblies may be used. Furthermore, other control configurations for dictating organic carbon dosing may be used.

Turning to FIG. 1c, a method of treating wastewater via a wastewater treatment system 100 will now be described. First, wastewater may be subjected to activated sludge-based biological treatment 104 in sequencing batch reactor 102 by alternating between aerobic phases 116 and anoxic phases 118, as shown in block 200.

An amount, an increase, and/or an elevated rate of increase of N2O in the activated sludge-based biological treatment 104 may be detected via N2O sensor 106 (i.e., an N2O detection), as shown in block 202. Such a detection may be made during the aerobic phases 116 and/or the anoxic phases 118. The N2O sensor 106 may generate a signal representing an N2O detection and transmit the signal to the control pump 110. In one embodiment, a signal may only be generated and/or transmitted upon such a detection. Exemplary rises in N2O during the anoxic phases 118 are shown in FIG. 1b.

Organic carbon may then be dosed from the external carbon source 108 to the activated sludge-based biological treatment 104 based on the reading/measurement of the N2O sensor 106, thereby controlling an N2O level of the activated sludge-based biological treatment 104 via the organic carbon, as shown in block 204. A dosing rate of the organic carbon may be determined based at least in part relative to a flow of the organic carbon into the sequencing batch reactor 102.

Organic carbon dosing may be discontinued or decreased when the N2O level of the activated sludge-based biological treatment 104 drops below a predetermined threshold, as shown in block 206. More broadly, organic carbon dosing may be altered (e.g., discontinued, decreased, initiated, or increased) upon a change (e.g., decrease, elevated rate of decrease, leveling off, increase, or elevated rate of increase) of N2O. The aforementioned secondary measurement of nitrite or nitrate may be used to continue organic carbon dosing until an effluent target is achieved.

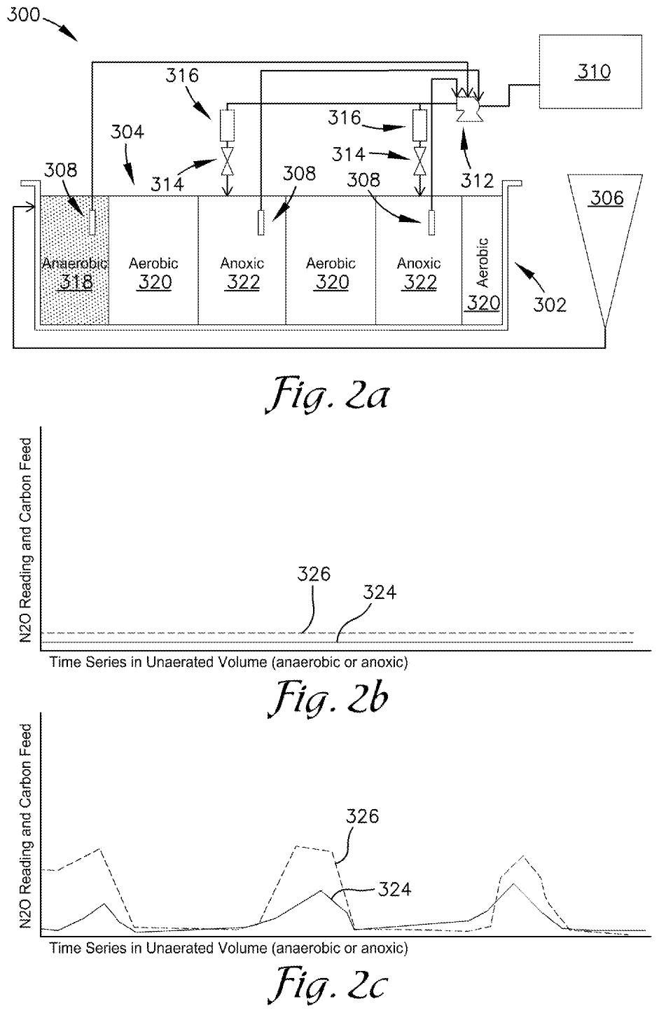

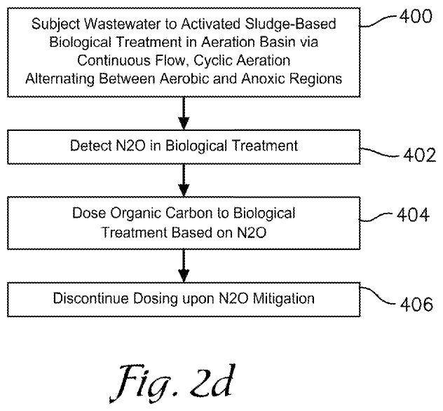

Turning to FIGS. 2a-c, a wastewater treatment system 300 constructed in accordance with another embodiment of the invention is illustrated. The wastewater treatment system 300 broadly comprises an aeration basin 302 for subjecting wastewater to an activated sludge-based biological treatment 304, a solids separation system 306, a plurality of N2O sensors 308, an external carbon source 310, a control pump 312, a plurality of control valves 314, and a plurality of flow meters 316.

The aeration basin 302 treats the wastewater by subjecting the wastewater to activated sludge-based biological treatment 304 from the solids separation system 306 via continuous flow, cyclic aeration. The aeration basin 302 forms an anaerobic region 318 and alternating aerobic regions 320 and anoxic regions 322 along a direction of flow. Specifically, aeration is applied to achieve aerobic conditions (thus forming the aerobic regions 320), and mixing with no aeration is applied to achieve anoxic conditions (and hence the anoxic regions 322). The system 300 is also applicable to include a region where anoxic conditions are present and aeration is supplied, which can be defined as a low dissolved oxygen zone or simultaneous nitrification denitrification zone.

The solids separation system 306 recirculates solids in the activated sludge-based biological treatment 304 to the aeration basin 302.

The N2O sensors 308 may be positioned in the aeration basin 302 in one or more of the anoxic regions 322 and may be communicatively coupled to the control pump 312. In other embodiments the N2O sensors 308 may be positioned in an anaerobic or aerobic region. The N2O sensors 308 may be configured to produce an N2O detection in the activated sludge-based biological treatment 304 in the corresponding region. For example, the N2O sensors 308 may be configured to detect an amount of N2O, generate a signal representative of the N2O amount, and transmit the signal to the control pump 312. The N2O sensors 308 or another sensor may also be configured to produce a secondary measurement detecting nitrite or nitrate.

The external carbon source 310 may be fluidly connected to the aeration basin 302 for providing organic carbon thereto. The organic carbon may be from at least one of a primary sludge fermentation system, a biomass fermentation system, and an external organic carbon feed product such as glycerol, methanol, acetate, or another compound that provides chemical oxygen demand.

The control pump 312 metes organic carbon from the external carbon source 310 to the activated sludge-based biological treatment 304 in one of the anoxic regions 322 of the aeration basin 302 according at least in part to the amount of N2O in the activated sludge-based biological treatment 304 of the corresponding region as detected by a corresponding N2O sensor 308. To that end, the control pump 312 may be communicatively connected to each one of the N2O sensors 308.

The control valves 314 may be fluidly connected between the control pump 312 and the aeration basin 302 and may be configured to ensure organic carbon is meted to the anoxic region 322 having a high or increasing N2O level. In one embodiment, fluid connection may include a feed assisted by gravity and/or an open fluid transfer (such as a pipe opening suspended over a basin).

The flow meters 316 may be fluidly connected between the control pump 312 and the control valves 314. Each flow meter 316 may be used to determine an amount or rate of organic carbon being delivered to the corresponding anoxic region 322 of the aeration basin 302. This may at least partially inform the control pump 312 to increase or decrease its output and/or a corresponding control valve 314 to increase or decrease flow.

Turning to FIG. 2d, a method of treating wastewater via wastewater treatment system 300 will now be described. First, the wastewater may be subjected to activated sludge-based biological treatment 304 in aeration basin 302 via continuous flow, cyclic aeration by forming an anaerobic region 318 and alternating aerobic regions 320 and anoxic regions 322, as shown in block 400.

An amount, an increase, and/or an elevated rate of increase of N2O may be detected (i.e., an N2O detection) via one of the N2O sensors 308 in the anaerobic region 318 or one of the anoxic regions 322, as shown in block 402. A corresponding N2O sensor 308 may generate a signal representing an N2O measurement and transmit the signal to the control pump 312. In one embodiment, a signal may only be generated and/or transmitted upon such a detection. Exemplary rises in N2O in the anaerobic region 318 and anoxic regions 322 are shown in FIG. 2c.

Organic carbon may then be dosed from the external carbon source 310 to a corresponding region of the activated sludge-based biological treatment 304 based on the reading/measurement of the corresponding N2O sensor 308, thereby controlling an N2O level of the corresponding region of the activated sludge-based biological treatment 304 via the organic carbon, as shown in block 404. A dosing rate of the organic carbon may be determined based at least in part relative to a flow of the organic carbon into the corresponding region. In one embodiment, organic carbon dosing is provided when N2O Is detected in a corresponding region—if no N2O is detected, the conditions for denitrification may not be carbon limited, and thus no external carbon is required.

Organic carbon dosing may be discontinued or decreased when the N2O level of the activated sludge-based biological treatment 304 in the corresponding region drops below a predetermined threshold, as shown in block 406. More broadly, organic carbon dosing may be altered (e.g., discontinued, decreased, initiated, or increased) upon a change (e.g., decrease, elevated rate of decrease, leveling off, increase, or elevated rate of increase) of N2O. The aforementioned secondary measurement of nitrite or nitrate may be used to continue organic carbon dosing until an effluent target is achieved.

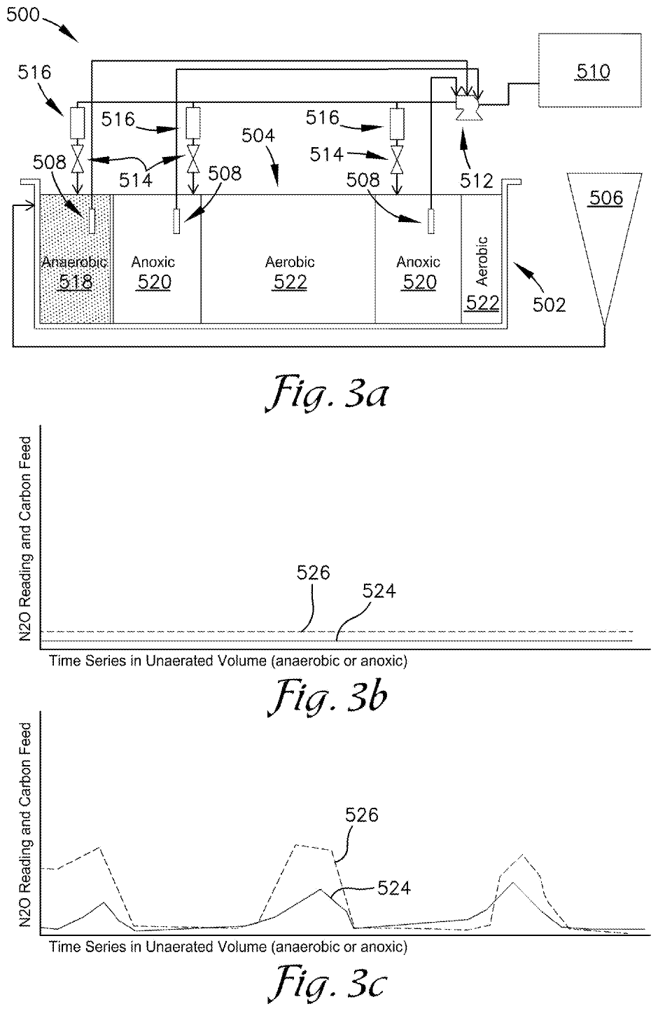

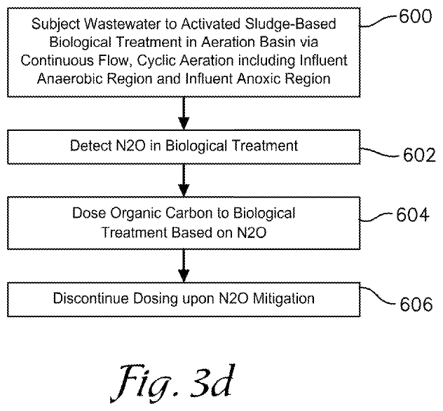

Turning to FIGS. 3a-c, a wastewater treatment system 500 constructed in accordance with another embodiment of the invention is illustrated. The wastewater treatment system 500 broadly comprises an aeration basin 502 for subjecting wastewater to an activated sludge-based biological treatment 504, a solids separation system 506, a plurality of N2O sensors 508, an external carbon source 510, a control pump 512, a plurality of control valves 514, and a plurality of flow meters 516. This wastewater treatment system 500 is similar to wastewater treatment system 300 described above except N2O control is primarily or exclusively focused on influent anerobic and/or anoxic regions.

The aeration basin 502 treats wastewater by subjecting the wastewater to activated sludge-based biological treatment 504 from the solids separation system 506 via continuous flow, cyclic aeration. The aeration basin 502 forms an anaerobic region 518 and alternating anoxic regions 520 and aerobic regions 522 along a direction of flow, with the anaerobic region 518 and one of the anoxic regions 520 being influent regions.

The solids separation system 506 recirculates solids in the activated sludge-based biological treatment 504 to the aeration basin 502.

The N2O sensors 508 may be positioned in the aeration basin 502 in at least the influent anaerobic region 518 and the influent anoxic region 520 and may be communicatively coupled to the control pump 512. Each N2O sensor 508 may be configured to produce an N2O detection in the activated sludge-based biological treatment 504 in a corresponding region. For example, an N2O sensor 508 may detect an amount of N2O, generate a signal representative of the N2O amount, and transmit the signal to the control pump 512. The N2O sensors 508 or another sensor may also be configured to produce a secondary measurement detecting nitrite or nitrate.

The external carbon source 510 may be fluidly connected to the aeration basin 502 for providing organic carbon thereto. The organic carbon may be from at least one of a primary sludge fermentation system, a biomass fermentation system, an external organic carbon feed product such as glycerol, methanol, acetate, or another compound that provides chemical oxygen demand.

The control pump 512 metes organic carbon from the external carbon source 510 to the activated sludge-based biological treatment 504 in a corresponding region according at least in part to the amount of N2O in the activated sludge-based biological treatment 504 as detected by a corresponding N2O sensor 508. To that end, the control pump 512 may be communicatively connected to each one of the N2O sensors 508.

The control valves 514 may be fluidly connected between the control pump 512 and the aeration basin 502 and may be configured to ensure organic carbon is meted to the corresponding region having a high or increasing N2O level. In one embodiment, fluid connection may include a feed assisted by gravity and/or an open fluid transfer (such as a pipe opening suspended over a basin).

The flow meters 516 may be fluidly connected between the control pump 512 and the control valves 514. Each flow meter 516 may be used to determine an amount or rate of organic carbon being delivered to the corresponding region. This may at least partially inform the control pump 512 to increase or decrease its output and/or a corresponding control valve 514 to increase or decrease flow.

It should be understood that other arrangements of the above control components, and other control assemblies may be used. Furthermore, other control configurations for dictating organic carbon dosing may be used.

Turning to FIG. 3d, a method of treating wastewater via wastewater treatment system 500 will now be described. First, wastewater may be subjected to activated sludge-based biological treatment 504 in aeration basin 502 via continuous flow, cyclic aeration by forming an influent anaerobic region 518 and alternating anoxic regions 520 (including an influent anoxic region) and aerobic regions 522, as shown in block 600.

An amount, an increase, and/or an elevated rate of increase of N2O may be detected (i.e., an N2O detection) via one of the N2O sensors 508 in at least one of the influent anaerobic region 518 and anoxic regions 520 (and particularly the influent regions), as shown in block 602. A corresponding N2O sensor 508 may generate a signal representing an N2O measurement and transmit the signal to the control pump 512. In one embodiment, a signal may only be generated and/or transmitted upon such a detection. Exemplary rises in N2O in the influent anaerobic region 518 and the anoxic regions 520 are shown in FIG. 3c.

Organic carbon may then be dosed from the external carbon source 510 to the corresponding region of the activated sludge-based biological treatment 504 based on the reading/measurement of the corresponding N2O sensor 508, thereby controlling an N2O level of the corresponding region of the activated sludge-based biological treatment 504 via the organic carbon, as shown in block 604. A dosing rate of the organic carbon may be determined based at least in part relative to a flow of the organic carbon into the corresponding region. In one embodiment, organic carbon dosing is provided when N2O Is detected in a corresponding region—if no N2O is detected, the conditions for denitrification may not be carbon limited, and thus no external carbon is required.

Organic carbon dosing may be discontinued or decreased when the N2O level of the activated sludge-based biological treatment 504 in the corresponding region drops below a predetermined threshold, as shown in block 606. Alternatively, organic carbon dosing may be discontinued or decreased upon a decrease of N2O, an elevated rate of decrease, or even a leveling off of N2O. The aforementioned secondary measurement of nitrite or nitrate may be used to continue organic carbon dosing until an effluent target is achieved.

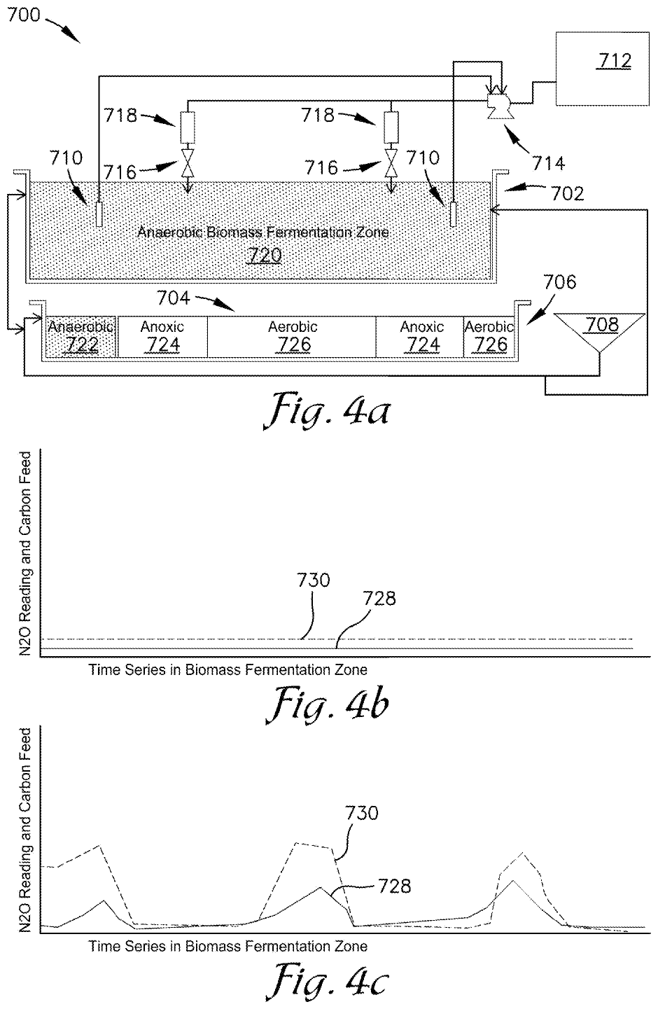

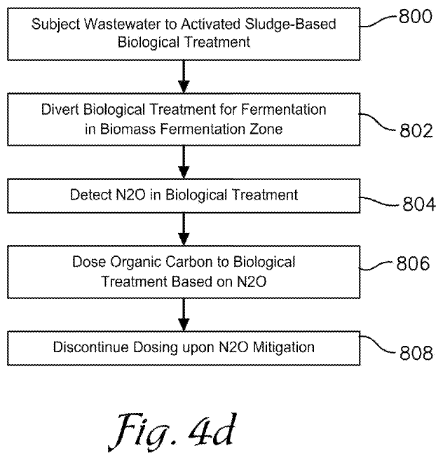

Turning to FIGS. 4a-c, a wastewater treatment system 700 constructed in accordance with another embodiment of the invention is illustrated. The wastewater treatment system 700 broadly comprises a fermentation basin 702 for fermentation of activated sludge-based biological treatment 704 (e.g., return activated sludge) via biological nutrient removal, an aeration basin 706 for subjecting wastewater to the activated sludge-based biological treatment 704, a solids separation system 708, a plurality of N2O sensors 710, an external carbon source 712, a control pump 714, a plurality of control valves 716, and a plurality of flow meters 718.

The fermentation basin 702 diverts at least some of the activated sludge-based biological treatment 704 downstream of the solids separation system 708 before the aeration basin 706 and creates an anaerobic biomass fermentation zone 720 in the activated sludge-based biological treatment 704. The anaerobic biomass fermentation zone 720 may include activated sludge-based biological treatment 704, mixed liquor, or a combination of both.

The solids separation system 708 recirculates solids in the activated sludge-based biological treatment 704 to the aeration basin 706 and the fermentation basin 702.

The N2O sensors 710 may be positioned in the fermentation basin 702 along a length of the fermentation basin 702 depending on a plug flow nature of the anaerobic biomass fermentation zone 720 and may be communicatively coupled to the control pump 714. Each N2O sensor 710 may be configured to produce an N2O detection in the activated sludge-based biological treatment 704 (and specifically in the anaerobic biomass fermentation zone 720). For example, an N2O sensor 710 may detect an amount of N2O, generate a signal representative of the N2O amount, and transmit the signal to the control pump 714. The N2O sensors 710 or another sensor may also be configured to produce a secondary measurement detecting nitrite or nitrate.

The external carbon source 712 may be fluidly connected to the fermentation basin 702 for providing organic carbon thereto. The organic carbon may be from at least one of a primary sludge fermentation system, a biomass fermentation system, and an external organic carbon feed product such as glycerol, methanol, acetate, or another compound that provides chemical oxygen demand.

The control pump 714 metes organic carbon from the external carbon source 712 to the activated sludge-based biological treatment 704 (and specifically the anaerobic biomass fermentation zone 720) according at least in part to the amount of N2O detected by the N2O sensor 710. To that end, the control pump 714 may be communicatively connected to each one of the N2O sensors 710. In one embodiment, the control pump is configured to dose organic carbon if N2O is measured along a length of the aeration basin 706.

The control valves 716 may be fluidly connected between the control pump 714 and the fermentation basin 702 and may be configured to ensure organic carbon is meted to the activated sludge-based biological treatment 704 as desired (e.g., locally or along the length of the aeration basin 706.

The flow meters 718 may be fluidly connected between the control pump 714 and the control valves 716. Each flow meter 718 may be used to determine an amount or rate of organic carbon being delivered to a specific region. This may at least partially inform the control pump 714 to increase or decrease its output and/or a corresponding control valve 716 to increase or decrease flow.

Turning to FIG. 4d, a method of treating wastewater via wastewater treatment system 700 will now be described. First, activated sludge-based biological treatment 704 from solids separation system 708 may flow to aeration basin 706 so that wastewater is subjected to the activated sludge-based biological treatment via continuous flow, cyclic aeration or the like in the aeration basin 706, as shown in block 800. As an example, the aeration basin 706 may form an influent anaerobic region 722 and alternating aerobic regions 726 and anoxic regions 724 (including an influent aerobic region) for nitrogen removal-see FIG. 4a.

Some of the activated sludge-based biological treatment 704 from the solids separation system 708 may be diverted to the fermentation basin 702, in which anaerobic biomass fermentation zone 720 is formed, for fermentation-see block 802. As mentioned above, anaerobic biomass fermentation zone 720 may include activated sludge-based biological treatment 704, mixed liquor, or a combination of both.

An amount, an increase, and/or an elevated rate of increase of N2O in the anaerobic biomass fermentation zone 720 may be detected (i.e., an N2O detection) via one of the N2O sensors 710, as shown in block 804. A corresponding N2O sensor 710 may generate a signal representing an N2O measurement and transmit the signal to the control pump 714. Such a signal may only be generated and/or transmitted upon such a detection.

Organic carbon may then be dosed from the external carbon source 712 to the anaerobic biomass fermentation zone 720 based on the reading/measurement of the corresponding N2O sensor 710, thereby controlling an N2O level of the anaerobic biomass fermentation zone 720 via the organic carbon, as shown in block 806. A dosing rate of the organic carbon may be determined based at least in part relative to a flow of the organic carbon into the anaerobic biomass fermentation zone 720. If N2O is measured along the length of the fermentation basin 702, dosing of organic carbon may either be initiated or increased to provide an N2O sink.

Organic carbon dosing may be discontinued or decreased when the N2O level of the activated sludge-based biological treatment 704 in the anaerobic biomass fermentation zone 720 drops below a predetermined threshold, as shown in block 808. Alternatively, organic carbon dosing may be discontinued or decreased upon a decrease of N2O, an elevated rate of decrease, or even a leveling off of N2O. The aforementioned secondary measurement of nitrite or nitrate may be used to continue organic carbon dosing until an effluent target is achieved.

The above-described systems and methods provide several advantages. The invention minimizes net N2O production during removal of nitrogen from influent wastewater in activated sludge processes. For example, the present invention exploits the relationship of the availability/deficiency of organic carbon as one of the leading contributors to N2O emissions from activated sludge processes. The addition of an external organic carbon feedstock to anaerobic, anoxic, or aerobic conditions provides a sink for N2O, thus limiting N2O emissions while also achieving lower effluent nitrogen concentrations for water quality protection. N2O detections are used as an indicator of carbon limited conditions, which can lead to nitrifier N2O production and/or denitrifier N2O production. Based on N2O detections, carbon dosing can be initiated and modulated to both limit N2O production and achieve improved biological nitrogen removal.

### ADDITIONAL CONSIDERATIONS

The description and drawings are illustrative and are not to be construed as limiting. Numerous specific details are described to provide a thorough understanding. However, in certain instances, well-known or conventional details are not described in order to avoid obscuring the description. References to one embodiment or an embodiment in the present disclosure are not necessarily references to the same embodiment; and, such references mean at least one.

The use of headings herein is merely provided for ease of reference, and shall not be interpreted in any way to limit this disclosure or the following claims.

References to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not for other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A wastewater treatment system comprising:
a basin configured to subject wastewater to an activated sludge-based biological treatment wherein nitrogen is removed from the wastewater;
an N2O sensor positioned in the basin and configured to produce an N2O detection in the biological treatment; and
an organic carbon source fluidly connected to the basin, the wastewater treatment system being configured to dose organic carbon from the organic carbon source to the biological treatment based on the N2O detection so that the wastewater treatment system controls an N2O level of the biological treatment via the organic carbon.

2. The wastewater treatment system of claim 1, wherein the basin is a sequencing batch reactor configured to cycle the biological treatment through aerobic and anoxic periods.

3. The wastewater treatment system of claim 1, wherein the wastewater treatment system is further configured to utilize continuous flow, cyclic aeration; the basin forming an anaerobic region and an anoxic region, the N2O sensor being positioned in at least one of the anaerobic region and the anoxic region, the wastewater treatment system being configured to dose the organic carbon into the anoxic region.

4. The wastewater treatment system of claim 1, further comprising an additional N2O sensor positioned in the basin, wherein the wastewater treatment system is further configured to utilize continuous flow, cyclic aeration; the basin forming an anaerobic region and an anoxic region, the N2O sensor being positioned in the anaerobic region, the additional sensor being positioned in the anoxic region, the wastewater treatment system being further configured to dose the organic carbon into the anaerobic region and the anoxic region.

5. The wastewater treatment system of claim 1, wherein the basin forms an anaerobic biomass fermentation zone.

6. The wastewater treatment system of claim 5, further comprising a plurality of N2O sensors including the N2O sensor, the plurality of N2O sensors being spaced apart from each other along a flow direction in the basin.

7. The wastewater treatment system of claim 1, further comprising at least one of a nitrite sensor and a nitrate sensor positioned in the basin, the wastewater treatment system being further configured to dose organic carbon from the organic carbon source to the biological treatment based on a reading of the at least one of the nitrite sensor and the nitrate sensor.

8. The wastewater treatment system of claim 1, wherein the organic carbon source is at least one of a primary sludge fermentation system, a biomass fermentation system, and an external organic carbon feed product and wherein the organic carbon source is at least one of glycerol, methanol, and acetate.

9. The wastewater treatment system of claim 1, wherein the wastewater treatment system is further configured to utilize at least one of nitrification (ammonium oxidation to nitrate), partial nitritation (ammonium oxidation to nitrite), denitrification with nitrite (nitrite reduction to nitrogen gas), partial denitritation (nitrate reduction to nitrite), and denitrification (nitrate reduction to nitrogen gas).

10. The wastewater treatment system of claim 1, wherein the wastewater treatment system is further configured to set a dosing rate relative to a flow of the organic carbon into the basin.

11. A method of treating wastewater, the method comprising steps of:
subjecting the wastewater to an activated sludge-based biological treatment in a basin wherein nitrogen is removed from the wastewater;
producing an N2O detection in the biological treatment via an N2O sensor; and
dosing organic carbon from an organic carbon source to the biological treatment based on the N2O detection thereby controlling an N2O level of the biological treatment via the organic carbon.

12. The method of claim 11, wherein the basin is a sequencing batch reactor, the subjecting step comprising cycling the biological treatment through aerobic and anoxic periods.

13. The method of claim 11, the subjecting step comprising:
forming an anaerobic region and an anoxic region in the biological treatment; and
utilizing continuous flow, cyclic aeration;
the producing step including detecting an amount of N2O in at least one of the anaerobic region and the anoxic region,
the dosing step including dosing the organic carbon into the anoxic region.

14. The method of claim 11, the subjecting step comprising:
forming an anaerobic region and an anoxic region; and
utilizing continuous flow, cyclic aeration;
the producing step including detecting an amount of N2O in the anaerobic region and the anoxic region, the dosing step including dosing the organic carbon into the anaerobic region and the anoxic region.

15. The method of claim 11, the subjecting step including forming an anaerobic biomass fermentation zone.

16. The method of claim 15, the producing step including taking N2O readings at spaced apart locations along a flow direction in the basin.

17. The method of claim 11, further comprising a step of detecting at least one of an amount of nitrite and an amount of nitrate in the biological treatment, the dosing step including dosing organic carbon from the organic carbon source to the biological treatment based on at least one of a nitrite reading and a nitrate reading of the detecting step.

18. The method of claim 11, wherein the organic carbon source is at least one of a primary sludge fermentation system, a biomass fermentation system, and an external organic carbon feed product, and wherein the organic carbon source is at least one of glycerol, methanol, and acetate.

19. The method of claim 11, wherein the subjecting step utilizes at least one of nitrification (ammonium oxidation to nitrate), partial nitritation (ammonium oxidation to nitrite), denitrification with nitrite (nitrite reduction to nitrogen gas), partial denitritation (nitrate reduction to nitrite), and denitrification (nitrate reduction to nitrogen gas).

20. A method of treating wastewater, the method comprising steps of:
subjecting the wastewater to an activated sludge-based biological treatment in a basin wherein nitrogen is removed from the wastewater, including:
forming an anaerobic region and an anoxic region in the biological treatment; and
utilizing continuous flow, cyclic aeration,
producing an N2O detection in at least one of the anaerobic region and the anoxic region; and
dosing organic carbon from an organic carbon source into the anoxic region of the biological treatment based on the N2O detection thereby controlling an N2O level of the biological treatment via the organic carbon,
wherein the organic carbon is from at least one of a primary sludge fermentation system, a biomass fermentation system, and an external organic carbon feed product including at least one of glycerol, methanol, and acetate, and
wherein the subjecting step utilizes at least one of nitrification (ammonium oxidation to nitrate), partial nitritation (ammonium oxidation to nitrite), denitrification with nitrite (nitrite reduction to nitrogen gas), partial denitritation (nitrate reduction to nitrite), denitrification (nitrate reduction to nitrogen gas), and anaerobic ammonium oxidation (Anammox).
